(19) United States
(12) Patent Application Publication
(10) Pub. No.: US 2010/0058232 A1
(43) Pub. Date: Mar. 4, 2010

(54) VIRTUAL NETWORK JOIN PROTOCOL

(75) Inventor: Suran De Silva, Saratoga, CA (US)

Correspondence Address: Patent Capital Group - Cisco, 6119 McCommas, Dallas, TX, 75214, US

(73) Assignee: CISCO TECHNOLOGY, INC., San Jose, CA (US)

(21) Appl. No.: 12/198,176

(22) Filed: Aug. 26, 2008

(51) Int. Cl. G06F 15/16; G06F 3/048

(52) U.S. Cl. 715/810; 709/227

(57) ABSTRACT

Disclosed are systems and methods that enable a host to join a virtual network, such as a VPN, for example. A protocol that may be used by such a system is also disclosed. Once virtual networks are implemented within an enterprise network for different purposes, this protocol allows a host to quickly and easily move around from one virtual network to another without changing its IP address or other host-specifics by which the host is tracked. Given that the host does not rely on classification capabilities of the switch/router, this mechanism allows the enterprise network to provide virtual networks for complex applications or communities in order to isolate application or community impacts, and for hosts to join and leave such networks as they want.

### BACKGROUND

A virtual private network (“VPN”) may be defined as a network connected together via securely encrypted communication tunnels over a public network, such as the public telephone infrastructure or the global Internet, for example. VPNs are also being used in large private enterprise networks for isolating traffic of partners, guests, departments, etc. VPN membership is usually based on configuration of the interface on the router/switch assigning an interface into the VPN.

Typically, users are assigned to VPNs statically. Some approaches to making this assignment more dynamic based on application classification at the router/switch have been presented. See, for example, U.S. patent application Ser. No. 12/036,408, filed Feb. 25, 2008, entitled “Shared L2 Bridging Domains For L3 Virtual Networks,” the disclosure of which is incorporated herein by reference.

Sometimes, it is difficult or cumbersome to handle all application-based VPNs via classification at the router/switch. Some applications are too complex (in terms of having multiple types of traffic and/or traffic that is tunneled, fragmented, or encrypted under multiple layers of headers) for the classification to be possible. It would be desirable if there were a simpler mechanism for providing VPNs that are universally accessible for such application-isolation purposes.

### SUMMARY

Described herein are systems and methods that enable a host to join a virtual network, such as a VPN, for example. A protocol that may be used by such a system is also described herein. Once virtual networks are implemented within an enterprise network for different purposes, this protocol allows a host to quickly and easily move around from one virtual network to another without changing its IP address or other host-specifics by which the host is tracked. Given that the host does not rely on classification capabilities of the switch/router, this mechanism allows the enterprise network to provide virtual networks for complex applications or communities in order to isolate application or community impacts, and for hosts to join and leave such networks as they want.

As described in detail herein, the host may initiate a virtual network query message, via which a user at the host may seek a list of virtual networks that are available for the host to join. A switch/router may receive an incoming query message from an associated host, and obtain a list of virtual networks the requesting host is authorized to access. The switch/router may relay to the host a query response containing the list of virtual networks the requesting host is authorized to access.

The host may provide the user with a visible list of virtual networks the requesting host is authorized to access, and enable the user to select a virtual network from the list. Responsive to the user's selection, the host may initiate a virtual network join request. The access switch receiving the join request may reconfigure the switchport for that host onto a secondary VLAN that corresponds to the selected virtual network, and redistribute pre-exiting ARP adjacencies of the host to the newly-joined virtual network. At this point, the host can now access services and the network quality of the newly-joined virtual network.

At any time, the host can perform the above-described process to join a different virtual network or to return to its default virtual network. A host may choose to join a virtual network at any time, for an unlimited or limited period of time.

### BRIEF DESCRIPTION OF THE DRAWINGS

FIG. 1 is a functional block diagram of an example physical network.

FIG. 2 is a flowchart of an example method for joining a virtual network.

FIGS. 3A and 3B depict example user interfaces that may be provided for joining a virtual network.

### DETAILED DESCRIPTION OF ILLUSTRATIVE EMBODIMENTS

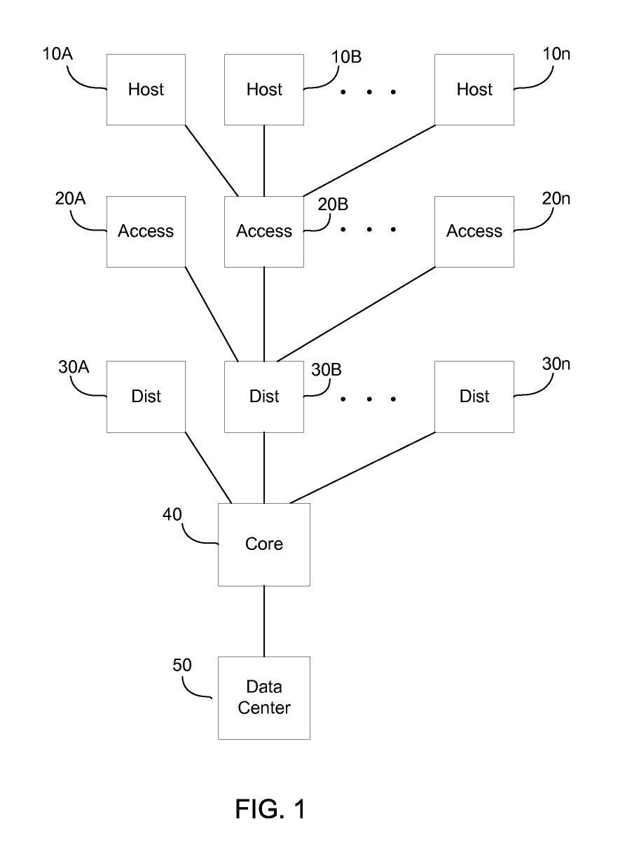

A virtual network provides virtual links between nodes in a physical computer network. An example physical network, as depicted in FIG. 1, may include a plurality of host computing devices 10A, 10B, . . . , 10n. Each host computing device 10A-n may be, for example, a desktop, laptop, or handheld computing device.

The network may include a plurality of access switches 20A, 20B, . . . , 20n. One or more host computing devices 10A-n may be coupled to an access switch (e.g., 20B). The host computing devices 10A-n may be coupled to the access switch 20B via an Ethernet local area network (LAN), for example. An access switch 20A-n may be referred to herein merely as a switch.

The access switch 20A-n may determine from an incoming message the output port of the access switch 20A-n from which to which to forward the message. An incoming message frame may include an address associated with the follow-on physical device (e.g., a Media Access Control (MAC) address). The access switch 20A-n may determine from the address provided in the incoming message frame the input port of the follow-on device to which to forward the message. An access switch 20A-n may be considered a first level of network aggregation for the host computing devices 10A-n.

The network may include a plurality of distribution switches 30A, 30B, . . . , 30n. One or more access switches 20A-n may be coupled to a distribution switch (e.g., 30B). A distribution switch 30A-n may be referred to herein as a router. The distribution switch 30A-n may deal with route summarization and access control, for example, among other things. The distribution switch 30A-n may route packets (e.g., internet protocol packets or any other layer-3 packets) to a core switch 40.

A plurality of distribution switches 30A-n may be coupled to the core switch 40. The core switch 40 may be referred to herein as merely the core. The core 40 may be a layer-3 switch. The core 40 may include a plurality of redundant physical core switches, to accommodate a switchover in case of failure. It should be understood that, in general, the network may include any number of host devices 10A-n, access switches 20A-n, distributions switches 30A-n, and core switches 40.

The core switch 40 may be coupled to a data center 50. The data center 50 may include any number of computer systems and associated components, such as server systems and storage systems, for example.

A user at one of the host computing devices, say, host 10B, for example, may perform an operation that requires accessing a device located in the data center 50. For example, the host 10B may perform an operation that requires access to a file server located in the data center 50. In such a scenario, the host 10B may send a packet that is initially aggregated at the access switch 20B to which the host 10B is coupled. The access switch 20B may forward the packet to the distribution switch 30B to which the access switch 20B is coupled. The distribution switch 30B may check the IP address found in the message for any restrictions. Assuming that there are no restrictions, the distribution switch 30B may forward the packet, using the layer-3 address, to the core 40. The core 40 may check the IP address and determine that the data center 50 is the intended destination. Once the packet from the host 10B arrives at the distribution center 50, a file server at the distribution center 50 may respond to the host 10B with a reply packet. The reply packet may be sent to the host device 10B via the same physical devices the original packet traversed to arrive at the data center 50 (i.e., core switch 40, distribution switch 30B, and access switch 20B).

A virtual local area network (VLAN) may be created by partitioning a physical local area network (LAN) into multiple subnets using a VLAN ID. The partitioned network can be on a single router, on multiple routers that would otherwise form a single physical network, or in a virtual private network (VPN).

A VPN may include multiple remote end-points (typically routers, VPN gateways of software clients, or the like). The end-points may be “joined” by a “tunnel” through another network, typically a third party network. Two such joined end-points may be referred to as a point-to-point (P2P) VPN. Connecting more than two end-points by putting in place a mesh of tunnels creates a “Multipoint VPN.”

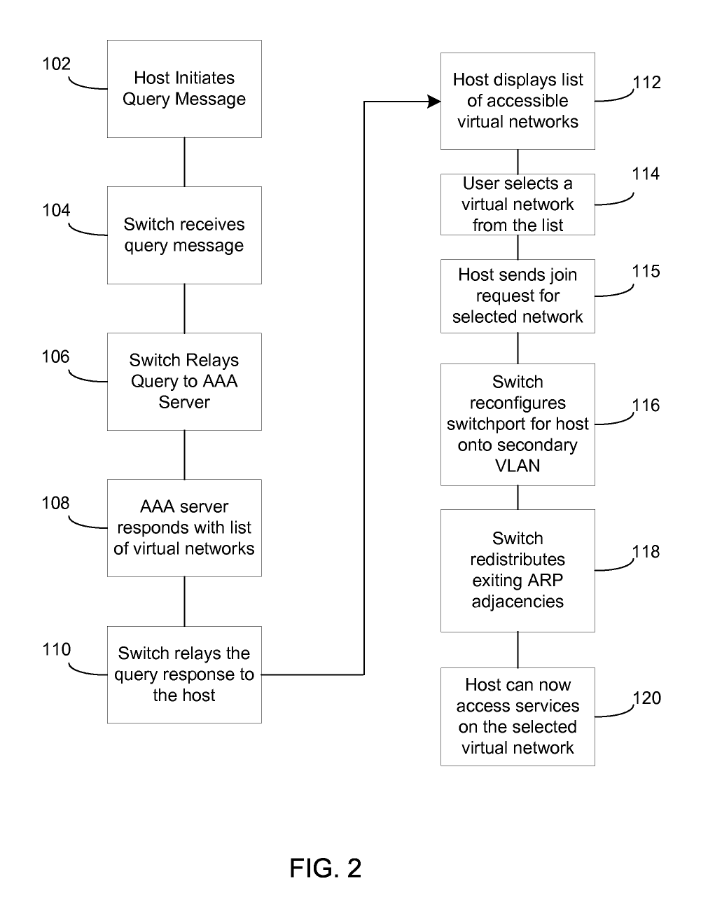

FIG. 2 is a flowchart of an example method 100 for joining a virtual network. One side of the protocol may run on a host computing device 10, while the other side runs on an access switch 20 or router 30.

The flowchart presented assumes that the host has already been identified by the network (e.g., through an identity-based networking services (“IBNS”) mechanism). The flowchart further assumes that the host has already been assigned a default VLAN on the access switch 20, and a default virtual network interface (VNET) on the distribution switch 30.

At 102, the host initiates a virtual network query message. A “virtual network query message,” as that term is used herein, refers to a protocol message sent from a host computing device 10 to either an access switch 20 or a distribution switch 30, via which the host 10 seeks a list of virtual networks that are available for the host 10 to join. The query message may include an identifier associated with the requesting host 10. An example of such a query message is an “all switches” multicast message.

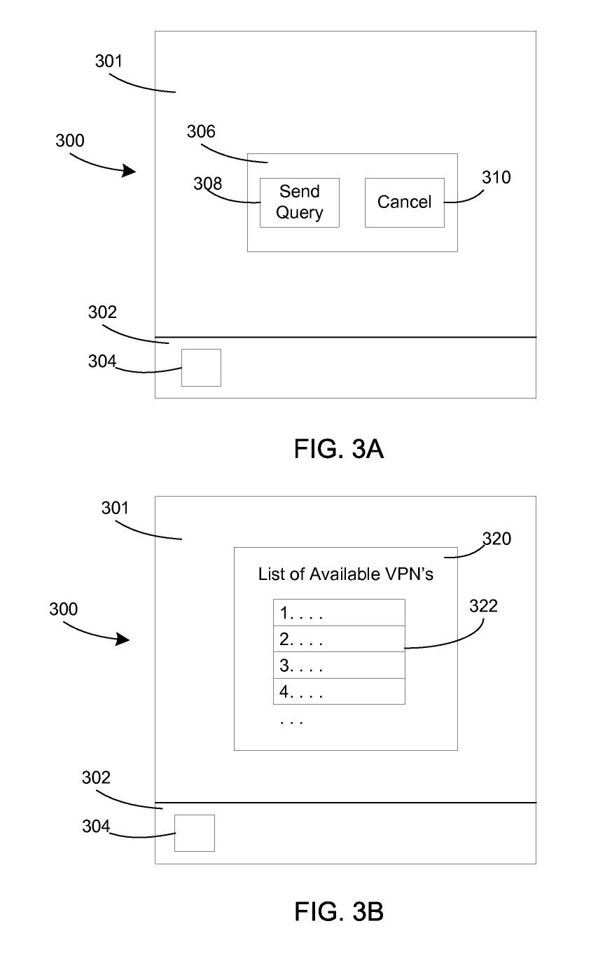

A program initiation mechanism, such as an icon, for example, may be provided to initiate the query process. An example user interface providing such a program initiation mechanism is depicted in FIG. 3A. As shown, the user interface 300 may include a desktop portion 301 and a system tray portion 302. An icon 304 may be displayed in the system tray portion 302. User selection of the icon (e.g., by pointing and clicking over the icon) may cause a pop-up window 306 to be displayed in the desktop portion 301 of the user interface 300. The pop-up window 306 may include a first option 308 that the user can select to cause the host device 10 to send a query message. The pop-up window 306 may also include a second option 310 that the user can select to cause the host device 10 to cancel the operation and not to send a query message.

Alternatively or additionally, a user could be enabled to initiate the query process by selecting a corresponding program from a list of programs available at the host device (e.g., by selecting a start program option (typically from a start button displayed in the system tray), and then selecting the corresponding program from a list of programs provided in response to selecting the start program option). The host could provide a “shortcut” icon in the desktop portion 301 of the user interface 300. Selecting the start program option or shortcut could result in the pop-up window 306 being displayed. It should also be understood that a query message could be initiated automatically by the host device upon completion of the identification/authentication process.

At 104, the switch/router may receive an incoming query message from one of its associated hosts. The switches 20 and routers 30 may be adapted to listen passively for query messages that may be coming in from any of its associated hosts.

At 106, the switch/router relays the received query message to an authentication/authorization/administration (“AAA”) server with the identity of the requesting host in the query. The AAA server may be the same server that is used for identification, such as a database off the core switch 40. The AAA server maintains a mapping of which virtual network(s) each host is authorized to access.

At 108, the AAA server responds to the switch/router with a list virtual networks the requesting host is authorized to access. At 110, the switch/router relay to the host a query response containing the list of virtual networks the requesting host is authorized to access. The reply message may include a respective name for each virtual network, or a respective numeric identifier.

At 112, the host provides a user interface that provides the user with a visible list of virtual networks the requesting host is authorized to access, and enables the user to select a virtual network from the list. An example user interface is depicted in FIG. 3B. As shown, the host device may display a pop-up window 320 that includes a list 322 of virtual networks the requesting host is authorized to access. The respective names of the virtual networks may be displayed in the list.

At 114, the user can select a selected virtual network from the list (e.g., by pointing and clicking over the list entry that corresponds to the desired virtual network). Responsive to the user's selection at 114, the host, at 115, may initiate a virtual network join request message. A join request message may include the name or numeric ID of the virtual network selected by the user.

At 116, the access switch receives the join request, and reconfigures the switchport for that host onto a secondary VLAN that corresponds to the selected virtual network. The same primary VLAN may be used so that re-addressing (e.g., re-ARPing) is not required. It should be understood that ARP (Address Resolution Protocol) is a standard method for finding a host's hardware address when only its network layer address is known.

The access switch may include a mapping of physical port to VLAN. The distribution switch may include a mapping of VLAN to virtual network. Accordingly, when the host user has decided which virtual network they want to join, the access switch may be reconfigured to map the port to another VLAN that is already associated with the selected virtual network.

At 118, the access switch may redistribute the pre-exiting ARP adjacencies of the host to the newly-joined virtual network. Note that the IP/MAC addresses of host need not change, because the new VLAN is in a different virtual network, and it is permissible to have the same IP address on different virtual networks. Accordingly, when traffic is sent from the distribution switch to the host, the IP address of the host may be mapped to the MAC address (which is hard-coded into the device) on the last hop.

At 120, the host can now access services and the network quality of the newly-joined virtual network. At this point, the host device is now natively on the new virtual network without having to perform any IP re-addressing, and without any impact on the L2 switching. It should be understood that there could still be port-based classification policies that classify easy-to-classify applications (e.g., voice traffic) onto a specific VNET, but all other traffic is on the new native virtual network without requiring any classification.

At any time, the host can at any time go through the above-described sequence to join a different virtual network or to return to its default virtual network. A host may choose to join a virtual network at any time, for an unlimited or limited period of time.

It should be appreciated that the above-described process provides a protocol with a thin client on the not necessarily thin host that allows the host to initiate a virtual network join onto any virtual network that it is authorized by the physical network to join, without any need for re-addressing the host. This allows the enterprise to create virtual networks for diverse communities and purposes without being limited by complex applications or end-host encryption. This provides for the traffic isolation, traffic engineering, and resource allocation benefits of network virtualization to be used for more purposes without limitations, as the user is able to dynamically select the virtual network to use at any given time.

Example scenarios for deployment of the systems and methods described herein will now be presented. An enterprise gaming network, for example, with lots of peer-discovery and peer-to-peer messaging can scale more easily by limiting the community without limiting the types of diverse and unpredictable application traffic such a community may need, while also protecting the rest of the network from this traffic. Such a community can enable safer usage of newer, intrusive network applications, such as live objects in enterprise networks, for example.

Beyond gaming and entertainment, such communities can enable training environments where scalable peer discovery and proactive peer-to-peer collaboration tools can be enabled safely, and without limiting the user in any way to end-to-end security or applications that are not classifiable by classification capabilities of the switches in the network. Training networks may be joined by hosts based on scheduled and registered courses, where the trainees, trainers, and servers join at scheduled times. A network management framework could be built upon this simple capability to better use network resources.

Other uses include multimedia-rich closed user groups used for implementing task force communities involved in collaboration sessions, and piloting IT network applications where users can join a pilot virtual network to sample more and more complex beta applications in a safe environment that doesn't risk the rest of the corporate network.

This is also useful where customers (such as financial enterprises, for example) that currently have separate physical networks for security reasons are looking to virtualize over a common physical network, but the users and administrators are uncomfortable relying on an application classification mechanism and/or need to use end-to-end host-based.

It should be understood that the above-described process does not rely on classification, permits end-host encryption, provides for an authorization by the network of the user before allowing the user to join a virtual network, and further ensures that traffic is not mixed across virtual networks for complex applications by avoiding reliance on classification. It provides the feel of two physical networks, without requiring the user to have two different end-nodes.

Virtual networks joined according to the above-described process can still employ shared servers where it is applicable and safe to do so. However, this process provides for less reliance on those mechanisms by making it easier for the user to switch virtual networks.

What is claimed:

1. A method for enabling a host device to establish a connection to a selected virtual network, the method comprising:
enabling the host device to identify a selected virtual network from a list of virtual networks that are accessible by the host;
connecting the host device to the selected virtual network.

2. The method of claim 1, further comprising:
initiating a virtual network query message from the host device, the virtual network query message containing a request for a list of virtual networks that are available for the host to join.

3. The method of claim 2, wherein the query message includes an identifier associated with the requesting host.

4. The method of claim 2, further comprising:
providing a user interface at the host device via which a user of the host device is enabled to initiate the query message.

5. The method of claim 1, receiving a query reply message containing a list of virtual networks the host device is authorized to access.

6. The method of claim 5, further comprising:
providing a user interface at the host device via which a user of the host device is enabled to select a selected virtual network from the list of virtual networks the host device is authorized to access.

7. The method of claim 1, further comprising:
initiating a virtual network join request message that includes an identifier associated with a selected virtual network the host device is authorized to access.

8. The method of claim 1, further comprising:
connecting the host device to the selected virtual network for a limited period of time.

9. A method for enabling a host device to establish a connection to a selected virtual network, the method comprising:
receiving a virtual network join request message that includes an identifier associated with a selected virtual network the host device is authorized to access.
connecting the host device to the selected virtual network by reconfiguring a switchport for the host device onto the selected virtual network.

10. The method of claim 9, further comprising:
receiving a virtual network query message from the host device, the virtual network query message containing a request for a list of virtual networks that are available for the host to join.

11. The method of claim 10, further comprising:
providing to the host device a query reply message containing a list of virtual networks the host device is authorized to access.

12. The method of claim 11, wherein the query reply message contains respective identifiers associated with the virtual networks the host device is authorized to access.

13. The method of claim 11, further comprising:
retrieving from a remote server the list of virtual networks the host device is authorized to access.

14. The method of claim 9, further comprising:
redistributing pre-exiting Address Resolution Protocol adjacencies of the host device to the selected virtual network.

15. The method of claim 9, further comprising:
connecting the host device to the selected virtual network for a limited period of time.

16. A physical computing network, comprising:
a host device adapted to provide a user interface that provides a list of virtual networks the host device is authorized to access, to accept a user selection from the list, and to initiate a virtual network join message; and
a switch/router adapted to connect the host device to the selected virtual network by reconfiguring a switchport for the host device onto the selected virtual network.

17. The network of claim 16, wherein the host device is further adapted to initiate a virtual network query message containing a request for a list of virtual networks that are available for the host to join.

18. The network of claim 17, wherein the switch/router is further adapted to provide to the host device a query reply message containing a list of virtual networks the host device is authorized to access.

19. The network of claim 18, wherein the host device is further adapted to provide a user interface via which a user of the host device is enabled to select the selected virtual network from the list of virtual networks the host device is authorized to access.

20. The network of claim 16, wherein the host device is connected to the physical network via the switchport, and wherein the switch/router is adapted to connect the host device to the selected virtual network by causing the switchport to be mapped to a virtual local area network that is associated with the selected virtual network.
